(19) United States
(12) Patent Application Publication
(10) Pub. No.: US 2010/0123031 A1
(43) Pub. Date: May 20, 2010

(54) Fluid oscillator assembly for fuel injectors and fuel injection system using same

(75) Inventor: James R. Weber, Lacon, IL (US)

Correspondence Address: CATERPILLAR c/o LIELL, MCNEIL & HARPER;Intellectual Property Department, AH9510, 100 N.E. Adams, Peoria, IL, 61629-9510, US

(73) Assignee: Caterpillar Inc.

(21) Appl. No.: 12/313,062

(22) Filed: Nov. 17, 2008

(51) Int. Cl. B05B 1/08; F15C 1/08

(52) U.S. Cl. 239/589.1; 239/5; 239/11; 137/14; 137/814; 137/826

(57) ABSTRACT

A fuel injection system includes a fuel injector that includes a nozzle assembly and at least one passageway that includes at least one fluid oscillator. The at least one passageway extends from a nozzle orifice, positioned on the outside of the fuel injector, to inside the fuel injector. Fuel from inside the fuel injector moves through the at least one fluid oscillator and oscillates between a high injection rate and a low injection rate as it moves through the at least one nozzle orifice and into the combustion chamber.

### TECHNICAL FIELD

The present disclosure generally relates to fuel injection systems and more particularly to fuel injection systems having the ability to spray fuel from a fuel injector into a combustion space in an oscillatory pattern to reduce undesirable emissions.

### BACKGROUND

In most fuel injection systems, fuel from a fuel injector is sprayed into a combustion space through one or more relatively tiny nozzle orifices at relatively high pressures. Fuel injectors control the injection of fuel from the fuel injector by opening and closing a needle check valve. Before an injection event begins, the needle check valve is in a closed configuration, preventing fuel from leaving the nozzle orifices of the fuel injector. When an injection event is initiated, the needle check valve is lifted to an open configuration, thereby allowing fuel to flow through the nozzle outlet. In a typical injection sequence, the needle check valve moves to an open configuration allowing an amount of fuel to move from inside the fuel injector to outside the fuel injector into a combustion chamber, and the needle check valve then returns to the closed configuration to end the injection event.

Engineers are continuously striving to improve combustion efficiency in fuel systems resulting in reduced unburned hydrocarbons and harmful emissions such as NOx as well as soot and smoke. NOx is produced in the periphery of the plume and the large unburned center adds to the production of soot and smoke. Combustion efficiency may be improved by better mixing the fuel and air. One way of improving combustion efficiency has been to raise injection pressures. However, due to technological limitations, manufacturing designs that are able to sustain ever increasing injection pressures become increasingly expensive and less cost effective.

Another way of improving combustion efficiency has been to inject fuel as pulses. U.S. Pat. No. 6,109,533 seeks to improve combustion efficiency by rapidly opening and closing the needle check valve during each injection cycle. By rapidly opening and losing the nozzle outlet, fuel is cyclically intermittently sprayed into the combustion space in such a way that better mixing occurs, which results in a more efficient burn.

The present disclosure is directed to overcoming one or more of the problems set forth above, including improving combustion efficiency, and hence reducing undesirable emissions, by injecting fuel in a manner different from that of the prior art.

### SUMMARY

In one aspect, a fuel injector includes a nozzle assembly. At least one passageway extends from inside the fuel injector to outside the fuel injector. At least one fluid oscillator is a part of the at least one passageway.

In another aspect, a method of operating a fuel injector with a nozzle assembly includes passing fuel from inside the fuel injector to outside the fuel injector by configuring the nozzle assembly to an open configuration. The passing fuel step includes oscillating fuel between a high injection rate and a low injection rate through at least one nozzle orifice.

In another aspect, a method of operating an engine includes compressing air inside a combustion chamber, and injecting fuel in to the combustion chamber from inside the fuel injector. The injecting step further includes oscillating fuel between a high injection rate and a low injection rate through at least one nozzle orifice.

### BRIEF DESCRIPTION OF THE DRAWINGS

FIG. 1 is a fuel injection system including a fuel injector partially disposed in a combustion chamber according to the present disclosure;

FIG. 2 is an enlarged front view of the nozzle tip shown in FIG. 1;

FIG. 3 is an enlarged sectional top plan view of the nozzle tip shown in FIG. 2 as viewed along section line 3-3; and

FIG. 4 is a schematic view of one of the fluid oscillators shown in FIG. 3.

FIG. 5a is a schematic view of one embodiment of a fluid oscillator according to the present disclosure;

FIG. 5b is a schematic view of another embodiment of a fluid oscillator according to the present disclosure;

FIG. 5c is a section view of yet another embodiment of a fluid oscillator according to the present disclosure.

### DETAILED DESCRIPTION

The present disclosure relates to the use of a fluid oscillator inside a fuel injector to improve combustion efficiency. A fluid oscillator creates an oscillatory flow pattern for fuel entering a combustion chamber by breaking up the injection stream and allowing smaller parcels of fuel to better mix with the air and hence, burn more efficiently, which results in a much improved combustion efficiency.

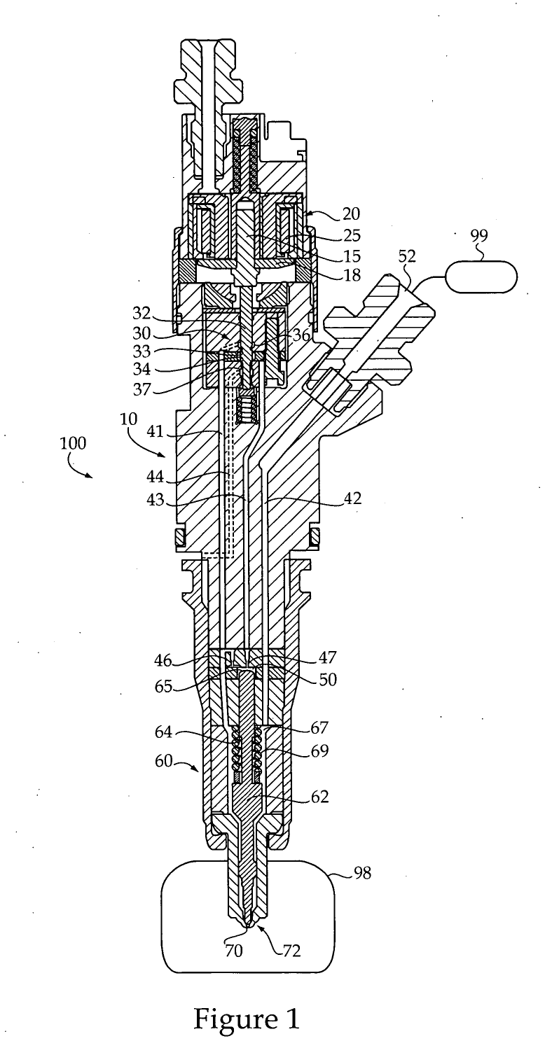

Referring to FIG. 1, a fuel injection system 100 includes a common rail fuel injector 10 fluidly connected to a common rail 99 and partially disposed within a combustion chamber 98. Because the present disclosure is applicable to a wide variety of fuel injectors, including common rail fuel injectors, cam actuated fuel injectors, hydraulically actuated fuel injectors among others, the common rail fuel injector shown in FIG. 1 is not intended to limit the scope of the present disclosure but rather represents any fuel injector that may fall within the scope of the present disclosure. The present disclosure specifically relates to any fuel injector that includes a passageway that extends from inside the fuel injector to outside the fuel injector, while having at least one fluid oscillator as a part of the passageway.

The fuel injector 10 includes a solenoid assembly 20 including an armature assembly 15 and a solenoid coil 26 that is either in an energized state or a de-energized state. The armature assembly 15 includes an armature 18 that is movable between a first and second armature position. A control valve assembly 30 includes a control valve member 32, which is operatively coupled to the armature assembly 15 and moves between an upper valve seat 33 and a lower valve seat 34. The fuel injector 10 further includes a nozzle assembly 60 that includes a needle check valve 62 movable between an open and closed configuration, and a nozzle spring 69 that biases the needle check valve to the closed configuration. The needle check valve 62 has an opening hydraulic surface 64 exposed to fluid pressure inside a nozzle chamber 67, and a closing hydraulic surface 65 exposed to fluid pressure inside a needle control chamber 50. The needle check valve 62 and the nozzle spring 69 may be disposed inside the nozzle assembly 60.

The control valve member 32 controls the movement of the needle check valve 62 by controlling the pressure in the needle control chamber 50. The needle check valve 62 in turn, controls the flow of fuel passing through a nozzle tip 70 to outside the fuel injector 10. The nozzle chamber 67 may receive fuel entering the fuel injector 10 from a rail inlet port 52 via a rail supply passage 42. In the present disclosure, the nozzle chamber 67 may be fluidly connected to the common rail 99, thereby maintaining rail pressure inside the nozzle chamber 67.

A valve supply passage 41 establishes a fluid connection between the nozzle chamber 67 and the control valve assembly 30. The valve supply passage 41 also fluidly connects the nozzle chamber 67 to the needle control chamber 50 via a first flow restrictor 46. A second flow restrictor 47, having a larger flow area than the flow area of the first flow restrictor 46, fluidly connects the needle control chamber 50 to either high-pressure fuel in valve supply passage 41 or to a low-pressure fuel drain passage 44 via the control valve assembly 30. The drain passage 44 is shown in dotted lines because the drain passage 44 lies in a plane not depicted in the section view shown in FIG. 1. Furthermore, the needle control chamber 50 remains fluidly connected to the nozzle chamber 67 via the first flow restrictor 46 regardless of the position of the control valve member 32.

When the solenoid assembly 20 is in a de-energized state, the armature assembly 15 is at the first armature position and the control valve member 32 is at the lower valve seat 34. A first annular opening 36 fluidly connects the high-pressure fuel from the nozzle chamber 67 to the needle control chamber 50 via the second flow restrictor 47 thereby increasing the pressure acting on the closing hydraulic surface 65 inside the needle control chamber 50 to rail pressure. The nozzle assembly 60 and the needle check valve 62 are in a closed configuration when the pressure acting on the closing hydraulic surface 65 is high enough to keep the needle check valve 62 in sealed contact with the nozzle tip 70. This allows the needle check valve 62 to fluidly block fuel inside the nozzle chamber 67 from entering the nozzle tip 70, thereby preventing any fuel from passing from inside the fuel injector 10 to outside the fuel injector 10.

Upon energizing the solenoid assembly 20, the armature assembly 15 moves to the second armature position and the control valve member 32 moves to the upper valve seat 33. When the control valve member 32 is moved to the upper valve seat 33, the second flow restrictor 47 fluidly connects the needle control chamber 50 to a low-pressure drain passage 44 via a second annular opening 37 and the pressure communication passage 43, thereby relieving pressure inside the needle control chamber 50 because the second flow restrictor 47 has a larger flow area than the first flow restrictor 46. The nozzle assembly 60 and the needle check valve 62 are in an open configuration when the pressure acting on the closing hydraulic surface 65 is reduced enough to move the needle check valve 62 out of sealed contact with the nozzle tip 70 and the pressure acting on the opening hydraulic surface 64 overcomes the combined force of the pressure acting on the closing hydraulic surface 65 and the force exerted by the nozzle spring 69. This allows the fuel inside the nozzle chamber 67 to pass through the nozzle tip 70 to outside the fuel injector 10.

Those skilled in the art may recognize that there are various ways of controlling the flow of fuel through the fuel injector 10 via the control valve assembly 30, such as allowing the needle check valve 62 to be directly controlled by the movement of the control valve member 32 by varying the pressure acting inside the needle control chamber 50. The present disclosure contemplates all fuel injectors that use alternate methods of controlling the flow of fuel through the fuel injector 10 as well.

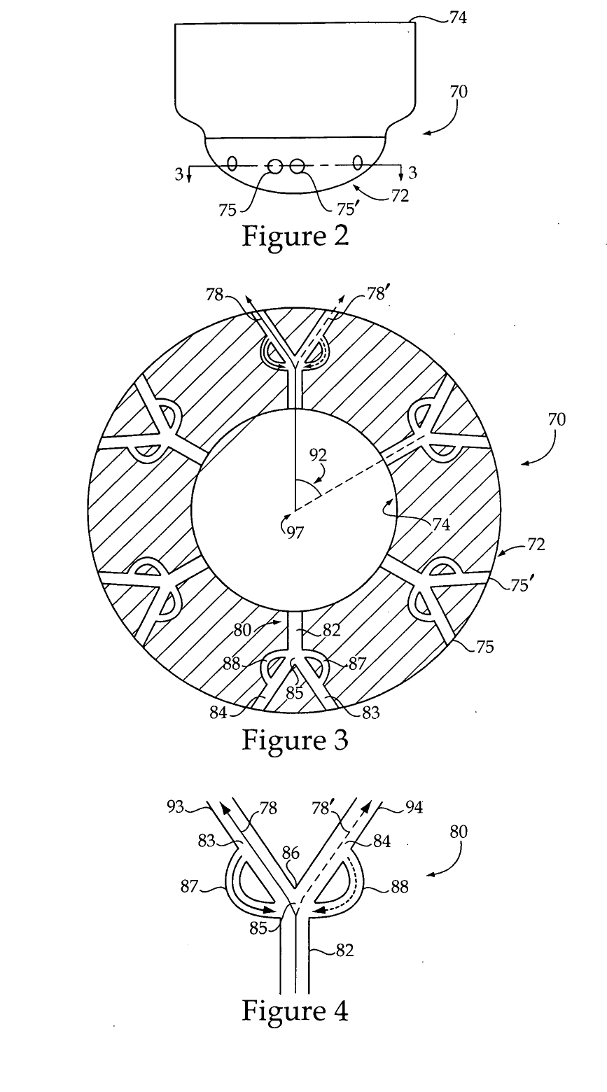

Referring also to FIGS. 2 and 3, the nozzle assembly 60 further includes a nozzle tip 70, which has an outer surface 72 and an inner surface 74, which is in sealed contact with the needle check valve 62 when the needle check valve 62 is in the closed configuration. The outer surface 72 of the nozzle tip 70 defines at least one nozzle orifice 75. Further, the nozzle tip 70 includes at least one passageway 78 extending from inside the fuel injector 10 to outside the fuel injector 10 via one of the at least one nozzle orifice 75. In the present embodiment, the at least one passageway 78 may be fluidly connected to the nozzle chamber 67 when the needle check valve 62 is in the open configuration but may be fluidly blocked from the nozzle chamber 67 when the needle check valve 62 is in the closed configuration.

The present disclosure teaches the incorporation of a fluid oscillator in a passageway extending from inside the fuel injector to outside the fuel injector. At least one passageway extending from inside the fuel injector to outside the fuel injector includes at least one fluid oscillator. According to the present disclosure, a fluid oscillator is defined as a passive structure having no moving parts that allows fuel flowing through the fluid oscillator to produce an oscillatory spray pattern. The oscillatory spray pattern may oscillate between a high injection rate and a low injection rate, oscillate directionally, or oscillate in both injection rate and direction.

Referring to FIG. 3 specifically, the present embodiment shows a nozzle tip 70 having six fluid oscillators 80, each having a first diffuser leg 83 and a second diffuser leg 84, separated by a Y-shaped flow splitter 85. Each of the six first diffuser legs 83 is fluidly connected to a corresponding nozzle orifice 75, while each of the six second diffuser legs 84 is fluidly connected to a corresponding nozzle orifice 75′, such that each nozzle orifice 75 or 75′ is fluidly connected to one diffuser leg 83 or 84 and each diffuser leg 83 or 84 is fluidly connected to one nozzle orifice 75 or 75′. Each of the six fluid oscillators 80 are equally spaced apart from the other fluid oscillators 80 and each of the six fluid oscillators 80 are separated from an adjacent fluid oscillator 80 by an equal angle 92 about a centerline (shown as dot 97 in section view) passing through the nozzle assembly 60.

The nozzle tip 70 defines twelve passageways 78 and 78′, each of which extends from the inner wall 74 of the nozzle tip 70 to a respective nozzle orifice 75 or 75′, such that each nozzle orifice 75 and a corresponding first diffuser leg 83 defines one passageway 78, and each nozzle orifice 75′ and a corresponding second diffuser leg 84 defines one passageway 78′. In FIG. 3, the lines labeled 78 and 78′ are two passageways that flow through each fluid oscillator 80. Each fluid oscillator 80 is a part of two passageways 78 and 78′, such that one fluid oscillator 80 is shared between two separate passageways 78 and 78′. In the embodiment shown in FIG. 3, the nozzle tip 70 includes six fluid oscillators 80 and twelve passageways 78 and 78′.

Referring now to FIG. 4, one of the fluid oscillators 80 defined in the nozzle tip 70 of FIG. 3 is shown. The fluid oscillator 80 includes a main stem 82, a Y-shaped splitter 85 and two diffuser legs 83 and 84. The flow splitter 85 traditionally assumes a triangular or trapezoidal shape, with a narrow leading edge 86 directly in the path of the fuel injection stream entering from the main stem 82. The flow splitter 85 partially defines the two diffuser legs 83 and 84 that diverge and exit the fuel injector 10. The fluid oscillator 80 includes outer walls 93 and 94 which partially define the two diffuser legs 83 and 84, as well as at least two feedback loops 87 and 88 leading from the diffuser legs 83 and 84 back into the main stem 82. Each feedback loop 87 or 88 will be disposed along one of the diffuser legs, 83 or 84, respectively. The diffuser legs 83 and 84 also fluidly connect to separate nozzle orifices 75 and 75′ positioned at the outer surface 72 of the nozzle tip 70. Each fluid oscillator defines two passageways 78 and 78′. One passageway 78 flows from the main stem to the first diffuser leg 83 while the second passageway 78′ flows from the main stem to the second diffuser leg 84. The two passageways 78 and 78′ are flow paths that flow out of nozzle orifices 75 and 75′, respectively. For the sake of simplicity however, the passageways and orifices throughout the application will be referred generally by the numerical references 78 and 75 respectively.

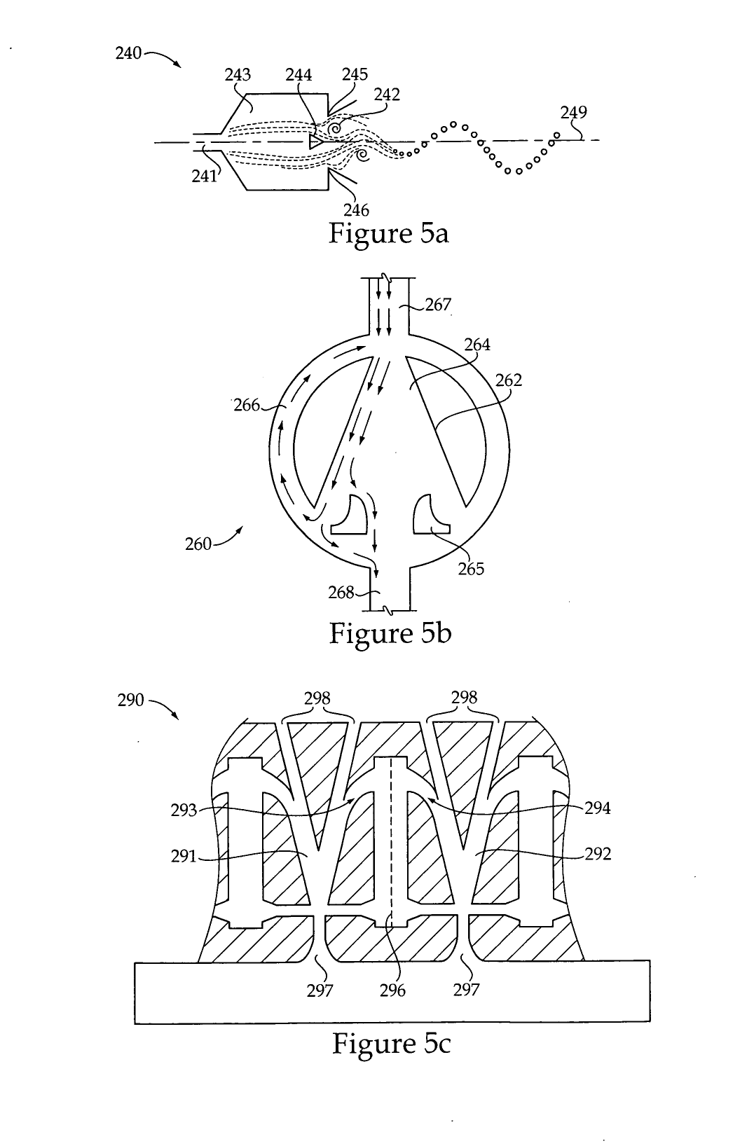

The present disclosure is not limited to embodiments described in this application but to other embodiments that may or may not yet be known that fall within the spirit of the disclosure. FIG. 5a-c shows three embodiments of fluid oscillators that may be defined in a fuel injector that may be used to produce an oscillatory spray pattern.

FIG. 5a shows a fluid oscillator 240 that may produce a spray pattern that oscillates directionally. The fluid oscillator 240 includes a chamber 243 having an inlet 241 and outlet 242. An obstacle or island 244 is positioned in the path of a fluid stream passing through the chamber 243 between inlet 241 and outlet 242. Island 244 is shown as a triangle, in plan, with one side facing upstream (i.e. toward inlet 241) and the other two sides facing generally downstream and converging to a point along the longitudinal center line 249 of the oscillator 240. Neither the shape, orientation, nor symmetry of the island 244 is limiting on the present embodiment. However, a blunt upstream-facing surface has been found to provide a greater vortex street effect than sharp, aerodynamically smooth configuration, while the orientation and symmetry of the island or obstacle has an effect on the resulting flow pattern issued from the fluid oscillator 240.

The outlet 242 is defined between two edges 245 and 246, which form a restriction proximate the downstream facing sides of island 244. This restriction is sufficiently narrow to prevent ambient fluid from entering the region adjacent the downstream-facing sides of island 244, the region where the vortices of the vortex street are formed. In other words, the throat or restriction between edges 245, 246 forces the liquid outflow to fill the region 242 therebetween and preclude entry of ambient fluid. The vortex street formed by island 244 causes the stream to cyclically sweep back and forth transversely of the flow direction.

FIG. 5b shows a fluid oscillator 260 having one input and one output, producing a pulsating spray pattern. The fluid oscillator 260 generally includes an oscillator body 261 having two attachment walls 262 defining an oscillating chamber 264 therebetween, an inlet 267 extended from the oscillating chamber 264, an outlet 268 extended from the oscillating chamber 264, a splitter 265 provided at the outlet 268, and two feedback channels 266 communicating with the oscillating chamber 264. When a flow of fluid passes to the oscillating chamber 264 through the inlet 267 to fill up the oscillating chamber 264, the fluid is guided to split at the splitter 265 to flow towards the outlet 268 and back to the oscillating chamber 264 through the feedback channels 266, such that the fluid is started to oscillate within the oscillating chamber 264. The oscillating effect of the fluid in the oscillating chamber 264 produces an injection stream that oscillates between a high injection rate and a low injection rate.

FIG. 5c shows a more complex fluid oscillator that may be used in the present disclosure. The complex fluid oscillator includes an array 290 of fluid oscillators that include a first fluid oscillator 291, a second fluid oscillator 292, a third fluid oscillator and so on. Details of two exemplary oscillators are illustrated in FIG. 5c. The array 290 of fluid oscillators includes a shared feedback chamber formed by fusing a second feedback line 293 of the first fluid oscillator 291 with a third feedback line 294 of second fluid oscillator 292. By this arrangement, the second feedback line 293 of the first fluid oscillator 291 and the third feedback line 294 of the second oscillator 292 supply the control fluid into the shared feedback chamber 296. The shared feedback chamber 296 thus provides a feedback flow path for the control fluid to the first fluidic oscillator 291 and the second fluidic oscillator 292 and thereby puts the first fluidic oscillator 291 in fluidic communication with the second fluidic oscillator 292. The array 290 of fluid oscillators may be fluidly connected to a series of passageways extending from inside the fuel injector to outside the fuel injector allowing fuel leaving the fuel injector to produce an oscillatory spray pattern. Fuel may flow through inlets 297 and flow out of the array 290 of fluid oscillators through outlets 298.

Other embodiments that fall within the scope of the present embodiment include a fuel injector wherein, each of the at least one passageway includes at least one fluid oscillator, such that fuel inside the fuel injector flows through at least one fluid oscillator before flowing out of the fuel injector. In one embodiment, a fuel injector may include only one nozzle orifice and one fluid oscillator. In yet another embodiment, a fuel injector may include at least one nozzle orifice that is fluidly connected to a passageway that does not include a fluid oscillator, and at least one nozzle orifice fluidly connected to a passageway that includes a fluid oscillator. However, in all embodiments of the present disclosure, the fuel injector should include at least one passageway extending from inside the fuel injector to outside the fuel injector that includes at least one fluid oscillator.

Those skilled in the art may appreciate that modern machining techniques, such as electrical discharge machining (EDM) or laser cutting may be employed in defining the fluid oscillator 80 inside the nozzle tip 70 of the fuel injector 10. Those skilled in the art may employ customary skill in the art to design such nozzle tips that include fluid oscillators. One way of manufacturing the nozzle tip is making the nozzle tip as two pieces and forming grooves of the fluid oscillator 80 in one piece or portions of each piece and attaching the two pieces together via suitable attachment methods known to those skilled in the art. Another way may include using EDM or lasers inserted through two nozzle orifices 75 to define the Y-shape and then rotating the electrodes or laser to make the feature at the junction of the Y-shaped splitter to produce the feedback loops.

Those skilled in the art may recognize that designing a suitable fluid oscillator for a desired oscillatory spray pattern may involve modeling and experimentation. The size of the passageway and the desired injection pressure among other factors, may be modeled and experimented with to reach the desired oscillatory spray pattern. The shape of the fluid oscillator and the sizes of its distinct portions may affect the direction and/or pressure of the oscillatory spray pattern. There may be further recognition by those skilled in the art of other issues that may affect oscillatory spray frequency and patterns include the fluid used and the injection pressure selected. Those skilled in the art may design fluid oscillators bearing in mind the fluid may be a nearly incompressible, slightly viscous, distilled diesel fuel and injection pressures are greater than 100 MPa. Additionally, spray patterns may vary when operating fuel injectors at different injection pressures and different fluids.

### INDUSTRIAL APPLICABILITY

The present disclosure finds potential application in fuel injectors and fuel systems in any engine or machine. The present disclosure has a general applicability in all fuel injectors injecting fuel in combustion chambers, and a particular applicability in fuel injection systems, including fuel injectors that inject fuel into combustion chambers, wanting better fuel and air mixing to occur.

The present disclosure teaches the use of a fluid oscillator to allow for better mixing between the fuel and air. The use of a fluid oscillator may break up an injection stream into smaller fuel packets in order to provide better mixing between the fuel packets and air, reducing Nox emissions, soot and smoke.

The fuel injection system 100 described herein includes a common rail fuel injector 10 fluidly connected to the common rail 99 and partially disposed in the combustion chamber 98. Typically, the fuel injector is electronically actuated to control the flow of fuel from inside the injector to outside the injector. Although the fuel injector 10 may include one of a variety of actuators, such as a solenoid or a piezo-electric actuator, to move the control valve assembly 30, the present embodiment includes a solenoid assembly 20 that has a solenoid coil 25, which is either de-energized or energized.

Before an injection event is initiated, the solenoid assembly 20 is in a de-energized state and the control valve member 32 is seated at the lower valve seat 34. The control valve member 32 blocks the fluid connection between the second annular opening 37 and the pressure communication passage 43, and instead allows the first annular opening 36 to fluidly connect the nozzle chamber 67 to the needle control chamber 50 via the pressure communication passage 43 allowing high pressure fuel to occupy both the nozzle chamber 67 and the needle control chamber 50. The pressure acting on the closing hydraulic surface 65 of the needle control chamber 50 along with the preload of the nozzle spring 69 applies a force on the needle check valve 62 that is greater than the pressure force inside the nozzle chamber 67 acting on the opening hydraulic surface 64 of the needle check valve 62. Because of the high pressure in the needle control chamber 50, the needle check valve 62 is biased towards the closed configuration. In the closed configuration, the needle check valve 62 fluidly blocks any fuel inside the fuel injector 10 to flow through the nozzle tip 70 and out the fuel injector 10. During this stage, no fuel is flowing through the fluid oscillator 80 or the nozzle orifices 75.

Upon initiating an injection event, the solenoid assembly 20 is energized and the control valve member 32 moves towards the upper valve seat 33. Once the control valve member 32 is seated at the upper valve seat 33, the control valve member 32 blocks the fluid connection between the first annular opening 37 and the pressure communication passage 43, and instead allows the second annular opening 36 to fluidly connect the needle control chamber 50 to the drain passage 44 via the pressure communication passage 43. Because the drain passage 44 is at a lower pressure than rail pressure, the pressure difference allows fuel inside the needle control chamber 50, to flow through the second flow restrictor 47 into the drain passage 44 via the second annular opening 36. The second flow restrictor 47 has a greater flow rate than the flow rate of the first flow restrictor 46. Therefore, fuel can leave the needle control chamber 50 via the second flow restrictor 47 faster than the fuel entering the needle control chamber 50 via the first flow restrictor 46. Hence, the pressure inside the needle control chamber 50 is relieved.

As the pressure inside the needle control chamber 50 drops, the pressure acting on the closing hydraulic surface 65 also drops. Eventually, the pressure acting on the opening hydraulic surface 64 exceeds the combined force of the pressure acting on the closing hydraulic surface 65 and the preload of the nozzle spring 69, causing the needle check valve 62 to move away from the nozzle tip 70, thereby allowing fuel to flow through the nozzle tip 70 and out the nozzle orifices 75. In order to initiate the injection event, the nozzle assembly is configured to an open configuration.

During the injection event, the nozzle chamber 67 expels the fuel as an injection stream into the nozzle tip 70 including the at least one passageway 78. The injection stream then flows into the fluid oscillator 80. Those skilled in the art may appreciate that the injection stream will cling to one side of main stem 82 due to a phenomenon called the Coanda effect. Thus, the fluid may flow through one of the two diffuser legs 83 and 84 at a time. Flow splitter 85 also helps guide the flow into either diffuser leg 83 or diffuser leg 84. As the fluid flows through one diffuser leg such as diffuser leg 83, feedback loop 87 will divert a portion of the fluid and return it to the main stem 82. The fluid inside the feedback loop 87 will then disturb the fluid flow along the side of main stem 82 closest to diffuser leg 83. This disturbance will cause the fluid flow to switch to the side of the main stem closest to fluid diffuser leg 84. Fluid will thus leave from diffuser leg 84, rather than from diffuser leg 83. As a result, the fluid oscillator may emit pulses of fluid in succession from the two diffuser legs 83 and 84, with diffuser leg 83 ejecting fluid at a higher injection rate than the diffuser leg 84 at a given time and diffuser leg 84 ejecting fluid at a higher injection rate than the diffuser leg 83 at another given time.

During an injection event according to the present disclosure, fuel moving from inside a fuel injector to outside the fuel injector moves in an oscillatory spray pattern through at least one nozzle orifice. The oscillatory spray pattern may oscillate between a high injection pressure and a low injection pressure, or oscillate directionally, or both depending on the fluid oscillator included in the nozzle tip.

During the injection event according to the present embodiment, the fuel injection stream oscillates between the two nozzle orifices 75 and 75′ fluidly connected to each fluid oscillator 80, causing the injection rate of the nozzle orifice 75 and 75′ to oscillate between a high injection rate and a low injection rate. In one embodiment, fuel may eject from both nozzle orifices 75 and 75′ at a given time although the injection rate in the nozzle orifice 75 will be relatively large while the injection rate in the nozzle orifice 75′ will be relatively small. The injection rates in both the nozzle orifices 75 will oscillate between a high injection rate and a low injection rate as long as the nozzle assembly 60 is in an open configuration. In one embodiment, the total injection rate of the fuel injector 10 may remain the same, but the injection rate of each nozzle orifice 75 and 75′ oscillates between a high injection rate and a low injection rate.

To end the injection event, the solenoid assembly 20 is de-energized and the control valve member 32 moves back from the upper valve seat 33 to the lower valve seat 34, thereby fluidly connecting the first annular opening 36 to the needle control chamber 50. Because the needle control chamber 50 may no longer be fluidly connected to the low-pressure drain passage 44 but instead, to the nozzle chamber 67 via the valve supply passage 41, high-pressure fuel begins to accumulate in the needle control chamber 50, thereby increasing the pressure acting on the closing hydraulic surface 65 of the needle check valve 62. This pressure acting on the closing hydraulic surface 65 combined with the preload of the nozzle spring 69 eventually exceeds the pressure acting on the opening hydraulic surface 64, and forces the needle check valve 62 to return to its closed configuration and stop any fluid from exiting the fuel injector 10 through the nozzle tip 70. Hence, no fuel will be flowing within the fuel injector 10 as the needle control chamber 50 and the nozzle chamber 67 are at the same fluid pressure and the drain passage 44 is no longer fluidly connected to the needle control chamber 50.

The present embodiment may be used to operate an engine including the fuel injection system 100. The fuel injector 10 may be partially disposed inside the combustion chamber 98 where air is being compressed. The fuel injector 10 injects fuel into the combustion chamber 98 from inside the fuel injector 10 when the nozzle assembly 60 is in an open configuration. The fuel injector 10 oscillates the injection pressure of the fuel being injected out from the nozzle orifices 75 and 75′ positioned on the outer surface 72 of the nozzle tip 70 of the fuel injector 10 by passing the fuel through at least one fluid oscillator 80. In one embodiment, the combustion chamber 98 compresses the air beyond the auto-ignition condition of fuel. Furthermore, in another embodiment, the fuel injection system 100 may compression-ignite the fuel inside the combustion chamber 98. Finally, in a common rail fuel injector system 100, initiating the injection event includes moving fuel from the common rail 99 into the fuel injector 10, and moving fuel from inside the fuel injector 10 to outside the fuel injector 10 by moving the needle check valve 62 to an open configuration.

In order to achieve higher combustion efficiencies, engineers have tried increasing injection pressures to reduce the size of fuel packets that leave the nozzle orifices of nozzle tips. Although high pressures may be important in producing smaller fuel packets, splitting up the injection stream by oscillating the flow of fuel between nozzle orifices may also improve combustion efficiency. By splitting an injection stream flowing through any nozzle orifice into fuel packets, and oscillating the fuel packets between nozzle orifices, each fuel packet may achieve better mixing with the air, resulting in a better combustion efficiency. Finally, the use of a fluid oscillator may produce an oscillatory spray pattern that may oscillate between a high injection pressure and a low injection pressure, or oscillate directionally, or oscillate both in direction and injection pressure, which may be desirable in many operations.

It should be understood that the above description is intended for illustrative purposes only, and is not intended to limit the breadth of the present disclosure in any way. Thus, those skilled in the art will appreciate that various modifications might be made to the presently disclosed embodiments without departing from the full and fair scope of the present disclosure. Other aspects, features and advantages can be obtained from a study of the drawings, and the appended claims

1. A fuel injector, comprising:
a nozzle assembly;
at least one passageway extending from inside the fuel injector to outside the fuel injector;
at least one fluid oscillator being a part of the at least one passageway.

2. The fuel injector of claim 1 wherein each of the at least one fluid oscillator includes a Y-shaped splitter and two feedback loops.

3. The fuel injector of claim 1 wherein each of the at least one fluid oscillator is separated from an adjacent fluid oscillator by an equal angle about a centerline through the nozzle assembly.

4. The fuel injector of claim 1 includes six fluid oscillators and twelve passageways.

5. A method of operating a fuel injector, including a nozzle assembly comprising the steps of:
passing fuel from inside the fuel injector to outside the fuel injector by configuring the nozzle assembly to an open configuration, wherein the step of passing fuel includes a step of:
moving fuel in an oscillatory spray pattern, through at least one nozzle orifice.

6. The method of operating a fuel injector of claim 5 wherein the step of moving fuel through at least one nozzle orifice includes the step of oscillating fuel flowing between a high injection rate and a low injection rate, through the at least one nozzle orifice.

7. The method of operating a fuel injector of claim 5 wherein the step of passing fuel includes the step of injecting the fuel inside a combustion chamber.

8. The method of operating a fuel injector of claim 6 wherein the step of oscillating fuel between a high injection rate and a low injection rate through at least one nozzle orifice includes the steps of:
moving fuel through at least one feedback loop; and
moving fuel through a Y-shaped splitter.

9. The method of operating a fuel injector of claim 5 further includes the steps of:
exposing an opening hydraulic surface of a needle check valve to fluid pressure in a nozzle chamber.

10. The method of operating a fuel injector of claim 9 further includes the steps of:
exposing a closing hydraulic surface of the needle check valve to fluid pressure in a needle control chamber; and
relieving pressure in the needle control chamber by fluidly connecting the needle control chamber to a drain.

11. The method of operating a fuel injector of claim 10 wherein the step of relieving pressure in the needle control chamber includes the step of moving a control valve member.

12. The method of operating a fuel injector of claim 5 wherein the step of passing fuel from inside the fuel injector to outside the fuel injector includes the steps of:
moving fuel from a common rail to a nozzle chamber; and
moving the fuel from the nozzle chamber to at least one fluid oscillator.

13. The method of operating a fuel injector of claim 5 further includes a step of stopping fuel from passing from inside the fuel injector to outside the fuel injector by configuring the nozzle assembly to a closed configuration.

14. The method of operating a fuel injector of claim 10 further includes the steps of:
stopping fuel from passing through the at least one passageway, which further includes a step of:
configuring the nozzle assembly to a closed configuration by increasing pressure in a needle control chamber by fluidly connecting the needle control chamber to rail pressure.

15. The method of operating a fuel injector of claim 13 wherein the step of configuring the nozzle assembly to a closed configuration includes the steps of:
moving a control valve member; and
moving a needle check valve to a closed configuration.

16. A method of operating an engine comprising the steps of:
compressing air inside a combustion chamber;
injecting fuel in to the combustion chamber from inside the fuel injector, wherein the injecting step further includes a step of:
moving fuel in an oscillatory spray pattern.

17. The method of operating an engine of claim 16 wherein the step of moving fuel in an oscillatory spray pattern includes the step of oscillating fuel between a high injection rate and a low injection rate through the at least one nozzle orifice.

18. The method of operating an engine of claim 16 wherein the step of compressing air in a combustion chamber includes the step of compressing air beyond the auto-ignition condition of fuel.

19. The method of operating an engine of claim 18 further includes a step of compression-igniting the fuel in the combustion chamber.

20. The method of operating an engine of claim 19 wherein the injecting step further includes the steps of:
moving fuel from a common rail to a fuel injector; and
moving a needle check valve from a closed configuration to an open configuration.
